(19) United States
(12) Patent Application Publication
(10) Pub. No.: US 2008/0024887 A1
(43) Pub. Date: Jan. 31, 2008

(54) Optical unit and imaging device

(75) Inventors: Takayuki Noda, Saitama-shi (JP); Eiichi Kabe, Saitama-shi (JP)

Correspondence Address: BIRCH STEWART KOLASCH & BIRCH, PO BOX 747, FALLS CHURCH, VA, 22040-0747, US

(73) Assignee: FUJINON CORPORATION

(21) Appl. No.: 11/878,755

(22) Filed: Jul. 26, 2007

(30) Foreign Application Priority Data
Jul. 28, 2006 (JP) P 2006-206627

(51) Int. Cl. G02B 3/00

(52) U.S. Cl. 359/819

(57) ABSTRACT

An optical unit includes an optical member through which light from an object passes and an optical lens barrel that surrounds an outer peripheral surface of the optical member and contains the optical member therein. One of a concave portion and a convex portion is provided in a first surface of the optical member. The other is provided in a second surface of the optical member. The first surface and the second surface are in contact with each other. The concave portion and the convex portion engage each other. Also, increase of manufacturing steps can be suppressed by utilizing a burr formed in a position on a parting line as the convex portion.

### CROSS-REFERENCE TO RELATED APPLICATIONS

This application is based upon and claims the benefit of priority from the Japanese Patent Application No. 2006-206627 filed on Jul. 28, 2006; the entire contents of which are incorporated herein by reference.

### BACKGROUND OF THE INVENTION

1. Technical Field

The invention relates to an optical unit that contains an optical member in an optical lens barrel and an imaging device for imaging a subject.

2. Description of the Related Art

In addition to the rapid progress in miniaturization of a digital camera, nowadays an imaging device for imaging an object to obtain a digital image is extensively built in a small electronic device such as a cellular phone, PDA (Personal Digital Assistant), and the like. Because the small electronic device that a user carries at all times every day is equipped with the imaging device, the user can take a picture easily at any time without trouble to carry a digital camera or a video camera. Also, it is common that a data communication function using radio, infrared radiation, or the like is installed previously into such a small electronic device. For this reason, the small electronic device has an advantage in that the user can immediately send the obtained image to another cellular phone, a personal computer, or the like at once on the spot.

However, in the imaging device that is largely smaller in size than the digital camera, a size of a lens used therein is also largely reduced. Thus, displacement in arrangement position of the lens may have a great influence on quality of the obtained image. As a result, it is necessary to fix the lens in a predetermined position in the lens barrel with high accuracy.

For this problem, JP 2005-309000 A (corresponding to US 2005/0231827 A) discloses devising a shape of a lens fitting groove provided in a lens barrel so that a burr formed by molding of a plastic lens does not displace a position of an optical axis of the plastic lens contained in the lens barrel from an axis of the lens barrel. According to the technology set forth in JP 2005-309000 A, a small lens that is susceptible to the influence of positional displacement can be arranged in a predetermined position in the lens barrel with good accuracy.

Also, with a size reduction of the lens, contacting surfaces between the lens and the lens barrel are reduced. Thus, an adhesive strength decreases, and the lens comes easily off the lens barrel. In the small imaging device, not only the step of aligning the lens in a fitting position with good accuracy but also the step of fixing the lens to the lens barrel without fail are required.

FIG. 1 is sectional views of a lens unit that contains a lens in a lens barrel, taken along a plane passing an optical axis. Here, it is assumed that the incident side (left side in FIG. 1) from which object light L (light from an object) is incident is referred to as a front side.

In a lens unit 10A shown in FIG. 1A, three lenses 12, 13, 14 are contained in a lens barrel 11A having an abutment portion 11a on its front side. These three lenses 12, 13, 14 are secured to an inner surface of the lens barrel 11A with an adhesive 15. In this lens unit 10A, a front surface of the lens 12 on the front side is brought into contact with the abutment portion 11a. Also, the lens 12 is adhered to the lens barrel 11A at two surfaces, that is, its front surface and its outer peripheral surface. Therefore, this configuration can surely prevent such a drawback that the lenses 12, 13, 14 come off the lens barrel 11A due to an impact caused by falling, or the like. In this case, since the abutment portion 11a is provided in the lens barrel 11A, a length of the lens unit 10A is extended in an optical axis direction. Thus, a thickness of the imaging device into which the lens unit 10A is installed is increased. In a small electronic device that a user always carries every day, such as a digital camera and a cellular phone, reduction in thickness is required particularly rather than reduction in height or width. As a result, reduction in a length L1 of the lens unit 10A in the optical axis is required.

In a lens unit 10B shown in FIG. 1B, a projection portion provided in the lens unit 10A in FIG. 1A is not provided in a lens barrel 11B that contains three lenses 12, 13, 14. Therefore, a length L2 of the lens unit 10B in the optical axis direction can be shortened. Thus, this lens unit 10B can be incorporated into the thin imaging device.

However, in the lens unit 10B shown in FIG. 1B, the lens 12 on the front side is adhered to the lens barrel 11B only at its outer peripheral surface. Also, the lenses 12, 13, 14 don't abut on its front side. As a result, when the user drops unintentionally the imaging device in which the lens unit 10B is incorporated, it is concerned that the lenses 12, 13, 14 are displaced by the impact applied to the lens unit 10B or the lens 12 on the front side comes off the lens barrel 11B. As a result, the user may not be able to take a picture.

### SUMMARY OF THE INVENTION

The invention has been made in view of the above circumstances, and provides an optical unit that can achieve both thickness reduction and improvement in durability against impact, and an imaging device using the optical unit.

According to an aspect of the invention, an optical unit includes an optical member and an optical lens barrel. Light from an object passes through the optical member. The optical lens barrel surrounds an outer peripheral surface of the optical member and contains the optical member therein. One of a concave portion and a convex portion is provided in a first surface of the optical member. The other is provided in a second surface of the optical member. The first surface and the second surface are in contact with each other. The concave portion and the convex portion engage each other.

With this configuration, a surface of the optical member through which the light from the object passes is not covered with the optical lens barrel. Therefore, a thickness of the optical unit in the optical axis direction can be reduced. Also, the optical member and the optical lens barrel are fixed firmly by not only adhesion using the adhesives but also the mutual engagement between the concave portion and the convex portion. Therefore, the durability against impact can be improved.

Also, in the optical unit of the invention, the concave portion is provided to the optical member, the optical lens barrel is molded such that split inner portions are pulled out while using a position corresponding to the concave portion of the optical member as a parting line, and the convex portion is a projection formed on the optical lens barrel in a position of the parting line.

In the manufacturing method of pouring the liquid material into a clearance between the mold and the mold and then removing the molds after the material is solidified, it is common that the projection (burr) is formed on the molded product in portions corresponding to coupled surfaces (parting line P) between the mold and the mold. In this case, the optical lens barrel is molded by using the mold that has the parting line in the position corresponding to the concave portion of the optical member, and then the projection (burr) formed on the optical lens barrel in the position of the parting line is utilized as the convex portion. Therefore, the invention can be implemented without adding a new manufacturing step.

According to another aspect of the invention, an imaging device includes the optical unit and an imaging device that receives the light which comes from the object and passes through the optical member, to generate an image signal.

With this configuration, both of thickness reduction of the imaging device and improvement in durability can be achieved.

Only the basic configuration of the imaging device is illustrated here. However, the imaging device of the invention includes not only the basic configuration but also various configurations corresponding to respective modifications of the optical unit.

According to the invention, both of thickness reduction of a device and improvement in durability against impact can be achieved.

### BRIEF DESCRIPTION OF THE DRAWINGS

FIG. 1 is sectional views of a lens unit that contains a lens in a lens barrel, taken along a plane passing an optical axis.

FIG. 2 is perspective appearance views of a cellular phone to which an embodiment of the invention is applied.

FIG. 3 is an internal block diagram of the cellular phone.

FIG. 4 is sectional views of the lens barrel that contains an imaging lens therein, taken along a plane passing an optical axis.

FIG. 5 is a schematic view of the lens on the front side.

FIG. 6 is a view explaining steps of manufacturing the lens barrel 200.

### DETAILED DESCRIPTION OF EMBODIMENTS OF THE INVENTION

Embodiments of the invention will be described with reference to the accompanying drawings hereinafter.

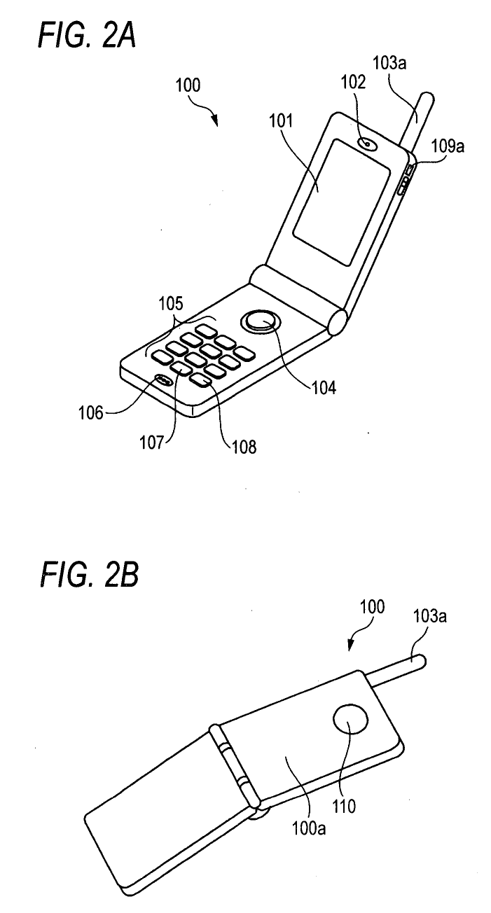

FIG. 2 is perspective appearance views of a cellular phone to which this embodiment of the invention is applied.

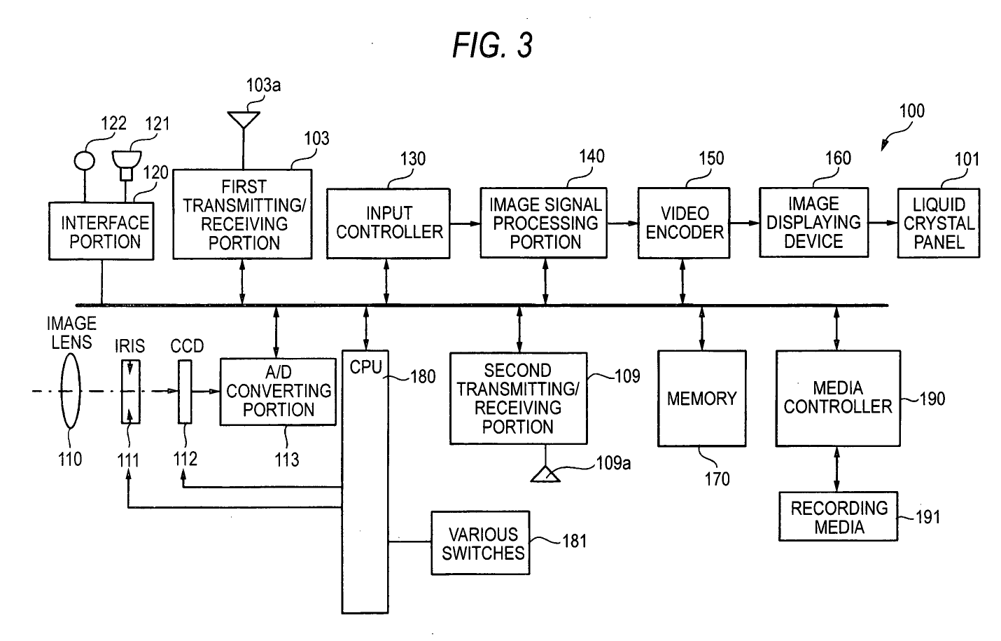

A front view of a cellular phone 100 is shown in FIG. 2A. A liquid crystal panel 101 for displaying a menu screen, a captured image, and the like is provided in a front surface of the cellular phone 100. A speaker (see FIG. 3) is arranged on the inside. Also, a mouthpiece 102 for producing a voice emitted from a speaker, a first antenna 103a for transmitting/receiving data such as voice, mail, and the like via a base station, a select button 104 used to select various functions and used as a shutter button to take a picture, push buttons 105 for inputting a phone number, an earpiece 106 for transmitting a voice to a microphone (see FIG. 3) that is arranged in this earpiece, an OK button 107 for defining the phone number that the user inputs, and the like, a power button 108, and a second antenna 109a for transmitting/receiving an image, address information, and the like by a short-distance radio communication without intervention of the base station are provided.

A rear view of the cellular phone 100 is shown in FIG. 2B. A imaging lens 110 is embedded in a main body case 100a on the rear surface of the cellular phone 100. The imaging lens 110 is constructed by a plurality of lenses, and these lenses are contained into the lens barrel. The imaging lens 110 and the lens barrel will be described in detail later.

In transmitting the voice, the electronic mail, and the like from the cellular phone 100, the user inputs a phone number, an electronic mail address, or the like by using the push buttons 105 and then presses the OK button 107. Then, the data are sent out to the designated destination of communication via radio communication. The data sent out from the cellular phone 100 are received once by the base station, and then are transmitted to the destination of communication from the base station via telephone line, LAN line, another base station, and the like. Conversely, the data sent out from the destination of communication are received by the base station and converted into radio data, and then are transmitted to the cellular phone 100.

Also, in shooting the subject by using the cellular phone 100, the user presses the select button 104 while aiming the imaging lens 110 shown in FIG. 2B at the subject, and then the shutter built in the cellular phone 100 is released to take a picture.

Next, an internal configuration of the cellular phone 100 will be described hereunder.

FIG. 3 is an internal block diagram of the cellular phone 100.

The imaging lens 110, an iris 111, a CCD 112, an A/D (Analog/Digital) converting portion 113, a microphone 121, a speaker 122, an interface portion 120, a first transmitting/receiving portion 103, an input controller 130, an image signal processing portion 140, a video encoder 150, an image displaying device 160, a second transmitting/receiving portion 109, a memory 170, a CPU 180, a media controller 190, and various switches 181 are provided to the inside of the cellular phone 100. Also, a recording media 191 is connected to the media controller 190.

The select button 104, the push buttons 105, and the like are contained in various switches 181. When various switches 181 are pressed, the effect that these switches are turned ON is transmitted to the CPU 180.

The CPU 180 gives the processing instructions to various elements of the cellular phone 100 shown in FIG. 3 and controls various elements. For example, when the select button 104 in FIG. 2 is pressed in a state that a shooting mode for taking a picture is set, the processing instructions are given to various elements shown in FIG. 3 from the CPU 180 and then the shooting is started.

Normally a plurality of lenses are provided to the imaging device that takes a picture of the subject. In this FIG. 3, a plurality of lenses are schematically illustrated as the imaging lens 110. Also, the iris 111 is a diaphragm that adjusts a quantity of light of the subject light that is received by the CCD 112.

When the shooting is started, the CCD 112 receives the subject light being passed through the imaging lens 110 and then reads an image of the subject based on the subject light as a subject signal as an analog signal. Here, this CCD 112 corresponds to an example of the imaging device claimed in the invention. The subject signal generated by the CCD 112 is converted into digital data of the picked-up image by the A/D converting portion 113. The converted data of the picked-up image are fed to the image signal processing portion 140 via the input controller 130.

In the image signal processing portion 140, image processings such as RGB level adjustment, gamma correction, etc. are applied to the image data, and also a compressing process is applied to the image data that were subjected to the image processings. The image data after compressed are fed once to the memory 170.

As the memory 170, SDRAM in which programs to be run in the cellular phone 100 are stored and which is used as an intermediate buffer whose recording speed is high, SRAM as a data save memory in which data of various menu screens, contents set by the user, etc. are stored, and VRAM in which compressed image data are stored are contained. The VRAM is divided into plural areas, and the image data are stored sequentially in plural areas. Then, the stored image data are read sequentially by the video encoder 150 and the media controller 190.

The video encoder 150 acquires the compressed image data from the memory 170 in compliance with the instructions from the CPU 180, and converts the compressed image data into the data format that can be displayed on the liquid crystal panel 101. The image data after converted are fed to the input controller 130, and the image that is produced by the image data is displayed on the liquid crystal panel 101 by the input controller 130. The media controller 190 is used to record the image data compressed and stored in the memory 170 on the recording media 191 and read the image data recorded in the recording media 191.

Also, when the phone number is input by using the push buttons 105 shown in FIG. 2 and then the OK button 107 is pressed, the phone number is set and the communication with the destination device is held. At this time, communication information such as the phone number of the cellular phone 100, the input phone number, etc. are transferred to the first transmitting/receiving portion 103 from the CPU 180, the communication information are converted in a radio wave and fed to the first antenna 103a, and the radio wave is radiated from the first antenna 103a. The radio wave radiated from the first antenna 103a is transmitted to the base station via common antennas (not shown) provided at respective locations such as buildings, telephone poles, etc. Then, the connection to the destination device, to which the designated phone number is assigned, is established at the base station.

As soon as the connection to the destination device is established, the user's voice being produced toward the cellular phone 100 is collected by the microphone 121 shown in FIG. 2, and then the collected voice is converted into a radio wave representing the voice data by the interface portion 120 and then is transmitted to the destination device by the first antenna 103a of the first transmitting/receiving portion 103. Also, the radio wave of the voice received via the first antenna 103a is converted into the voice data by the interface portion 120, and emitted as the voice from the speaker 102 shown in FIG. 2. Not only the voice data but also the mail data of the mail using the mail address instead of the phone number are transmitted/received by the first antenna 103a of the first transmitting/receiving portion 103. The mail data that were received by the first antenna 103a and digitized by the first transmitting/receiving portion 103 are stored in the memory 170 by the input controller 130.

Also, apart from the communication interface (the first antenna 103a, the first transmitting/receiving portion 103) used to communicate with the destination device such as other cellular phone via the base station, the radio communication interface (the second transmitting/receiving portion 109, the second antenna 109a) used to communicate via a short-distance radio communication without intervention of the base station is provided to this cellular phone 100. As the communication interface for the short-distance radio communication, infrared transmission, Bluetooth, and the like can be applied. In this embodiment, the infrared transmission is applied as the communication interface. When the infrared rays transmitted directly from other cellular phone, or the like are received by the second antenna 109a, an electric signal based on the received infrared rays is picked up by the second transmitting/receiving portion 109 and then converted into digital data. On the contrary, when the data are to be transmitted to the external device, such data are transferred to the second transmitting/receiving portion 109. The data are converted into the radio wave by the second transmitting/receiving portion 109 and radiated from the second antenna 109a.

When the infrared rays representing the image are received by the second antenna 109a, the electric signal based on the infrared rays is converted into image data by the second transmitting/receiving portion 109. Like the picked-up image data, the converted image data are sent to the image displaying device 160 and then the image represented by the image data is displayed on the liquid crystal panel 101 or recorded on the recording media 191 via the media controller 190.

The cellular phone 100 is constructed basically as above.

Here, in the cellular phone 100 of this embodiment, the imaging lens 110 is surely fitted to the lens barrel. Therefore, when the user drops the cellular phone 100 unintentionally, such a drawback can be avoided that the imaging lens 110 comes off the lens barrel. Next, the configurations of the imaging lens 110 and the lens barrel will be described in detail hereunder.

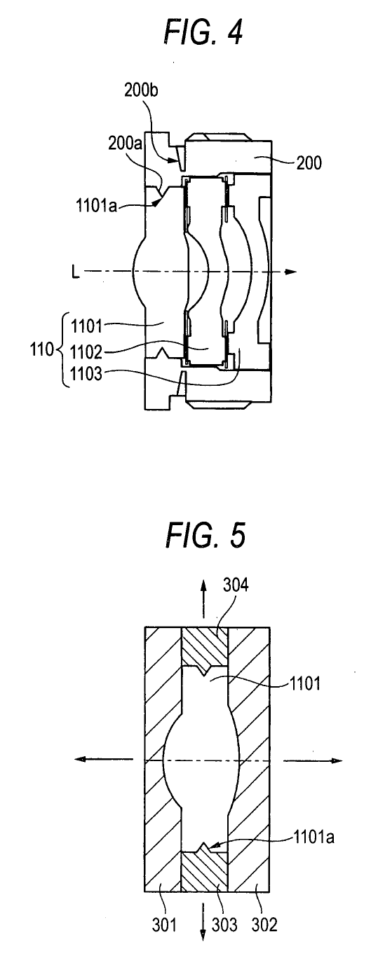

FIG. 4 is sectional views of the lens barrel that contains an imaging lens therein, taken along a plane passing an optical axis. Here, it is assumed that the incident side (left side in FIG. 4) from which light L from an object is incident is referred to as a front side.

As shown in FIG. 4, the imaging lens 110 is includes three lenses 1101, 1102, 1103. These lenses 1101, 1102, 1103 are contained in a lens barrel 200. An adhesive is applied between outer peripheral surfaces of the lenses 1101, 1102, 1103 and an inner surface of the lens barrel 200. Only one surface (outer peripheral surface) of each of the lenses 1101, 1102, 1103 is adhered to the lens barrel 200.

FIG. 5 is a schematic view of the lens 1101 on the front side.

The lens 1101 on the front side is molded by an assembly mold having two lateral pieces 301, 302 and two vertical pieces 303, 304.

The assembly mold constructed by assembling the two lateral pieces 301, 302 and the two vertical pieces 303, 304 together has an inner surface that is shaped into the lens 1101. This lens 1101 is molded by pouring a transparent liquid material (e.g., a transparent plastic) into the assembly mold and then removing the lateral pieces 301, 302 laterally and the vertical pieces 303, 304 and vertically after the material is solidified.

Also, convex portions surrounding the object light L is provided in the vertical pieces 303, 304. As a result, a groove 1101a is formed on an outer peripheral surface, which surrounds the subject light L, of the lens 1101 on the front side. Here, the lens 1101 corresponds to a non-limited example of an optical member. Also, the groove 1101a corresponds to a non-limited example of a concave portion.

Meanwhile, as shown in FIG. 4, a notch 200b is provided on an outer peripheral surface of the lens barrel 200. A convex portion 200a that engages the groove 1101a of the lens 1101 on the front side is formed on an inner surface of the lens barrel 200. Here, the lens barrel 200 corresponds to a non-limited example of an optical lens barrel, and the convex portion 200a corresponds to a non-limited example of a convex portion and a projection.

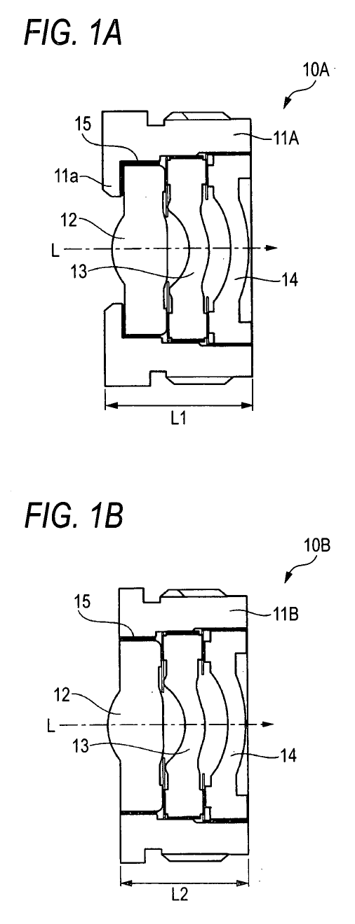

The abutment portion 11a shown in FIG. 1 is not provided in the lens barrel 200. Front surfaces and rear surfaces of the lenses 1101, 1102, 1103 are not covered. Therefore, a thickness reduction of the lens barrel 200 in the optical axis direction is achieved.

When the lens 1101 on the front side is pushed into the lens barrel 200, the lens barrel 200 is deflected because of the presence of the notch 200b. Thus, the lens 1101 is fitted to the foremost surface. At this time, the convex portion 200a formed on the inner surface of the lens barrel 200 is fitted into the groove 1101a provided in the lens 1101 on the front side. The lenses 1101, 1102, 1103 are secured to the lens barrel 200 firmly. Therefore, even though the adhered surface between the lenses 1101, 1102, 1103 and the lens barrel 200 is small, the lenses 1101, 1102, 1103 are surely fixed to the lens barrel 200.

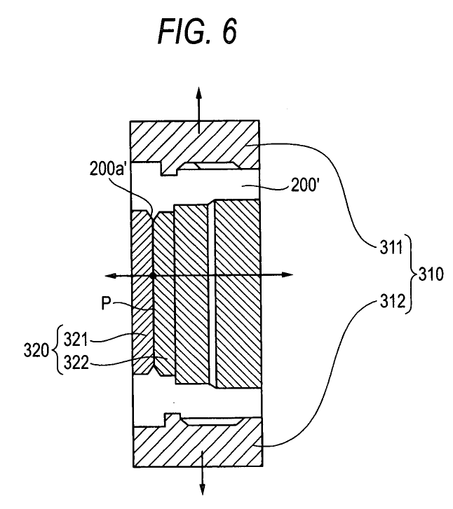

FIG. 6 is a view for explaining steps of manufacturing the lens barrel 200.

In this embodiment, the lens barrel 200 is molded by using two outer mold pieces 311, 312 and two inner mold pieces 321, 322.

An outer mold 310 formed by assembling the two outer mold pieces 311, 312 has a hollow cylindrical shape. An inner surface of the outer mold 310 is formed to fit a shape of an outer surface of the lens barrel 200 exactly.

An outer peripheral surface of an inner mold 320 formed by assembling the two inner mold pieces 321, 322 is formed to fit a shape of an inner surface of the lens barrel 200 exactly. Also, in the molded lens barrel 200, coupled surfaces (parting line P) of the two inner mold pieces 321, 322 are designed so as to be located in a position corresponding to the groove 1101a of the lens 1101 shown in FIG. 5.

First, the outer mold pieces 311, 312 and the inner mold pieces 321, 322 are assembled respectively, and the inner mold 320 is set on the inside of the outer mold 310.

Then, a liquid material 200′ (e.g., a plastic or a metal) is poured into a gap between the outer mold 310 and the inner mold 320.

After the material 200′ is solidified, the outer mold 310 is removed by disassembling the outer mold pieces 311, 312. Then, the inner mold 320 is removed by disassembling the inner mold pieces 321, 322. Thus, the lens barrel 200 is molded.

In this case, the liquid material 200′ tends to come in a gap 200a′ between the inner mold pieces 321, 322, so that a burr is apt to be formed in a position of the parting line P after the inner mold 320 is removed. As described above, since the parting line P of the inner mold pieces 321, 322 is provided in the position corresponding to the groove 1101a of the lens 1101 shown in FIG. 5, the burr is formed in the position corresponding to the groove 1101a of the lens 1101 of the molded lens barrel 200. In this embodiment, the burr formed in this manner is utilized as the convex portion 200a.

In this manner, in this embodiment, the convex portion (burr) 200a formed on the inner surface of the lens barrel 200 is fitted into the groove 1101a provided on the lens 1101 on the front side. Thus, the lenses 1101, 1102, 1103 are secured firmly to the lens barrel 200. Therefore, even though the user drops the cellular phone 100 unintentionally, such a drawback can be avoided surely that the lenses 1101, 1102, 1103 are displaced or come off the lens barrel 200. Also, since the burr formed in molding the lens barrel 200 is utilized as the convex portion that is fitted into the concave portion of the lens 1101, complication of manufacturing steps can be lessened.

In the above description, the example in which the concave portion is provided in the optical member and the convex portion is provided in the optical lens barrel is explained. Also, the convex portion may be provided in the optical member and the concave portion may be provided in the optical lens barrel.

In the above description, the example in which the concave portion and the convex portion are provided in the contact surface of the optical member on the front side and the optical lens barrel is explained. Also, the concave portion and the convex portion may be provided in all contact surfaces of respective optical members and the optical lens barrel.

In the above description, the cellular phone is illustrated as a non-limited example of the imaging device mentioned of the invention. However, the digital camera, or the like may be employed as the imaging device of the invention.

In the above description, the CCD is illustrated as a non-limited example of the imaging device of the invention. However, a CMOS sensor may be employed as the imaging device of the invention.

What is claimed is:

1. An optical unit comprising:
an optical member through which light from an object passes; and
an optical lens barrel that surrounds an outer peripheral surface of the optical member and contains the optical member therein, wherein:
one of a concave portion and a convex portion is provided in a first surface of the optical member,
the other is provided in a second surface of the optical member,
the first surface and the second surface are in contact with each other, and
the concave portion and the convex portion engage each other.

2. The optical unit according to claim 1, wherein:
the concave portion is provided in the first surface of the optical member,
the optical lens barrel is molded by pulling out inner portions with positions corresponding to the concave portion of the optical member being used as a parting line, and
the convex portion is a projection formed in the second surface of the optical lens barrel in a position on the parting line.

3. The optical unit according to claim 1, wherein a third surface of the optical member through which the light from the object passes is not covered with the optical lens barrel.

4. The optical unit according to claim 1, wherein the optical member comprises one lens.

5. An imaging device comprising:
the optical unit according to claim 1; and
an imaging device that receives the light which comes from the object and passes through the optical member, to generate an image signal.
